(19) United States
(12) Patent Application Publication
(10) Pub. No.: US 2018/0283624 A1
(43) Pub. Date: Oct. 4, 2018

(54) MULTI-FUNCTIONAL BLUETOOTH LIGHTING DEVICES

(71) Applicant: Aixia Bian, Shanghai (CN)

(72) Inventor: Aixia Bian, Shanghai (CN)

(21) Appl. No.: 15/801,479

(22) Filed: Nov. 2, 2017

Related U.S. Application Data
(63) Continuation of application No. 15/581,848, filed on Apr. 28, 2017.
Application No. 15/581,848 is a continuation of application No. 15/475,644, filed on Mar. 31, 2017.

(51) Int. Cl. F21L 4/08; F21V 31/00; F21V 23/04; F21V 21/40; F21V 21/14

(52) U.S. Cl. CPC F21L 4/08; F21V 31/00; F21V 23/0414; F21V 21/406; F21Y 2115/10; F21V 21/145; F21K 9/64; F21V 29/89; F21V 29/773

(57) ABSTRACT

A portable multi-functional light with two functions is controlled by a remote. A method of using a multi-functional light includes connecting the multi-functional light to a first and a second remote using a first and a second transceiver. The first and second remotes are authenticated. The light receives a signal from the first remote with a first instruction for a first function and the second remote with a second instruction for a second function. The light interprets the first instruction and second instruction using a processor into a first or second command, respectively. The processor communicates the first and second command to the first or second function of the device, respectively.

### REFERENCE TO RELATED APPLICATIONS

The present application claims priority to U.S. application Ser. No. 15/581,848, filed on Apr. 28, 2017, and U.S. application Ser. No. 15/475,644, filed on Mar. 31, 2017, the contents of both of which are incorporated herein by reference in their entirety.

### TECHNICAL FIELD OF THE INVENTION

The present description relates generally to portable devices used for illuminating spaces.

### BACKGROUND OF THE INVENTION

Advances in technology have enabled lighting devices to become increasingly lightweight and portable. Light emitting diodes (LEDs) are capable of efficiently converting electrical energy into light with little waste heat, allowing them to provide extended illumination with portable energy sources, such as batteries.

Portable lanterns and the like are used in a variety of situations. Some are used for area illumination in spaces without dedicated lighting. Others are used for increasing visibility in hard to reach places like under vehicles. These devices are especially useful in the event of external power loss.

It is an object of this disclosure to provide an improved portable lighting solution that can be carried by a user to provide light in the area they are working as needed.

It is a further object of this disclosure to provide an improved portable lighting solution with a longer lasting power source.

It is a further object of this disclosure to provide an improved portable lighting solution that is dust and water resistant.

### SUMMARY OF THE INVENTION

A method of using a multi-functional lighting device includes connecting the multi-functional lighting device to a first and a second remote using a first and a second transceiver. The first and second remotes are authenticated. The lighting device receives a signal from the first remote with a first instruction for a first function and the second remote with a second instruction for a second function. The lighting device interprets the first instruction and second instruction using a processor into a first or second command, respectively. The processor communicates the first and second command to the first or second function of the device, respectively.

Another method of controlling a multi-functional lighting device with a first remote includes connecting the multi-functional lighting device to the first remote in addition to connecting at least a second remote. The remote provides a user identification to the multi-functional lighting device from the first remote. The remote then sends a signal from the remote with an instruction relating to one of at least two functions of the multi-functional lighting device. The remote receives a status update from the light relating to the function from the multi-functional lighting device.

The disclosure further provides a remote controlled multi-functional lighting device with a first function and a second function. The lighting device provides a lighting element positioned in a housing and a battery system coupled to an inside of the housing and operably connected to and enabling the lighting element to emit light. Within the lighting device, a first receiver and a second transceiver are configured to connect the multi-functional lighting device to a first remote and a second remote, respectively. The transceivers can receive a signal from the first remote with a first instruction for the first function or the second remote with an second instruction for the second function. A controller within the lighting device is configured to authenticate the first and second remotes and interpret the first instruction or second instruction using a processor into a first or second command, respectively. Upon receiving first or second command, the controller executes the first and second command to the first or second function of the device, respectively.

### BRIEF DESCRIPTION OF THE DRAWINGS

FIG. 1 is a perspective view of the portable lighting device according to the methods of this disclosure.

FIG. 2 is a perspective view of the portable lighting device of FIG. 1 with the stand deployed.

FIG. 3 is a back perspective view of the folded portable lighting device.

FIG. 4 is a front view of the portable lighting device.

FIG. 5 is a back view of the portable lighting device.

FIG. 6 is a left view of another example portable lighting device.

FIG. 7 is a right view of the portable lighting device.

FIG. 8 is a bottom view of the portable lighting device.

FIG. 9 is a top view of the portable lighting device.

FIG. 10 is a rear view of a first example audio lighting device of the present invention.

FIG. 11 is a bottom view of the first example audio lighting device of FIG. 8.

FIG. 12 is a front view of the first example audio light of FIG. 8.

FIG. 13 is a front perspective view of the first example audio light of FIG. 8.

FIG. 14 is a rear perspective view of the first example audio light of FIG. 8.

FIG. 15 is another front perspective view of the first example audio light of FIG. 8.

FIG. 16 is a perspective view of the first example audio light of FIG. 8 connected to an example bar.

FIG. 17 is an enlarged perspective view of the first example audio light of FIG. 8 disconnected from the example bar.

FIG. 18 is a left side view of the first example audio light of FIG. 8.

FIG. 19 is a right side view of the first example audio light of FIG. 8.

FIG. 20 is a top view of the first example audio light of FIG. 8.

FIG. 21 is a rear view of a second example audio light of the present invention.

FIG. 22 is a bottom view of the second example audio light of FIG. 19.

FIG. 23 is a front view of the second example audio light of FIG. 19.

FIG. 24 is a front perspective view of the second example audio light of FIG. 19.

FIG. 25 is another front perspective view of the second example audio light of FIG. 19.

FIG. 26 is a rear perspective view of the second example audio light of FIG. 19 connected to an example cable.

FIG. 27 is a left side view of the second example audio light of FIG. 19.

FIG. 28 is a right side view of the second example audio light of FIG. 19.

FIG. 29 is a top view of the second example audio light of FIG. 19.

FIG. 30 is a flowchart of the method of using a remote controlling a portable light according to the teachings of this disclosure.

### DETAILED DESCRIPTION OF THE INVENTION

The following description of example methods and apparatus is not intended to limit the scope of the description to the precise form or forms detailed herein. Instead the following description is intended to be illustrative so that others may follow its teachings.

In the following description, the terms “water resistant” or “dust resistant” are used. These terms are set under ANSI/IEC-60529 which promulgates certain standards for the degrees of protection granted against intrusion by both solid objects and water. Solid objections include dust, debris, and even accidental conduct by the user's body during use. The terms “water resistant” or “dust resistant” on their own do not necessarily mean that no dust or no water will enter the device.

The terms “light emitting diode” and “LED” are also used in the following description. One of ordinary skill will appreciate that an LED describes a wide variety of two lead semiconductors that emit light by electroluminescence when a voltage differential is applied. LED lights can be made in a variety of sizes and typically come in either through-hole or surface mount configurations.

The term “phosphorescence” is also used in the following description. Phosphorescence refers to a mechanism by which a material fluoresces when exposed to radiation. This mechanism is associated with unsuitable energy state transitions in quantum mechanics. A phosphorescence material does not immediately re-emit the radiation it absorbs, but instead absorbed radiation is re-emitted at a lower intensity for up to several hours after the original excitation.

The present application discloses a multi-functional high efficiency LED Area portable light. The portable lighting device includes a cross shaped housing with a front portion and a back portion. In the front portion, an LED lighting element is centrally positioned. Part of the housing is a series of aluminum cooling fins. A rotatable stand and handle are connected to the housing at the top and bottom respectively. At the rear of the portable light, a switch and charging port are built into the rear portion of the housing.

The example multi-functional portable lighting device may be powered via replaceable or rechargeable batteries. In some instances, the portable lighting device includes a charging port into which a connector of a power source can be inserted to supply power to rechargeable batteries of the multi-functional portable light. In other instances, the multi-functional portable lighting device includes a receptacle with conductive contacts into which one or more batteries may be inserted for powering the portable light.

In one example situation, the user, when additional lighting is needed as in a power outage or repair task, uses the switch to activate the LED lighting element. The user can use the stand and mounting point to locate and secure the portable lighting device in the most helpful location. The charging port can be used to power the device or recharge the battery. After the user is finished, the user can use the switch to disable the light.

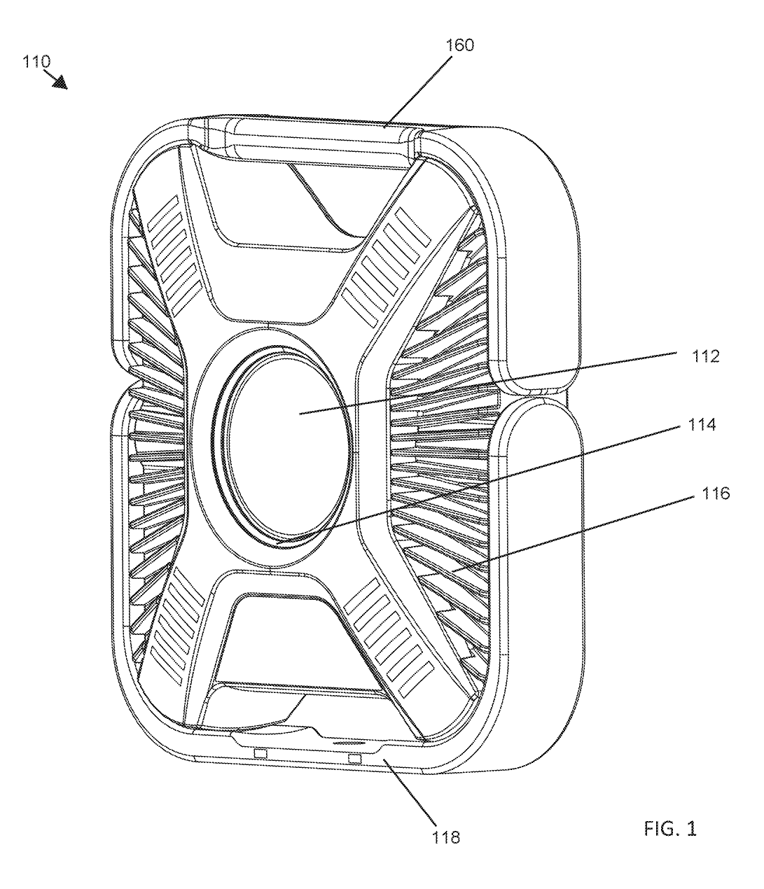

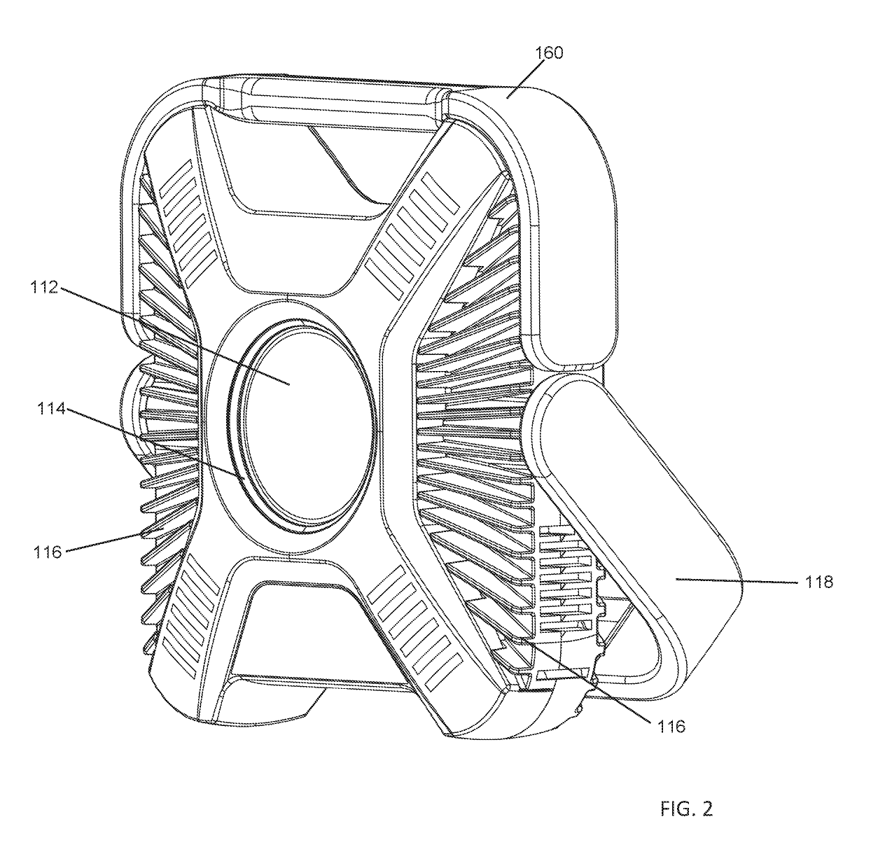

Referring now to FIG. 1, an example of a portable lighting device 110 is shown. In the example portable lighting device 110, the housing 116 is shaped in an “x” or cross configuration and has a rotating support bracket 118, shown extended in FIG. 2. This example configuration efficiently distributes the material to maximize strength while minimizing material usage and costs.

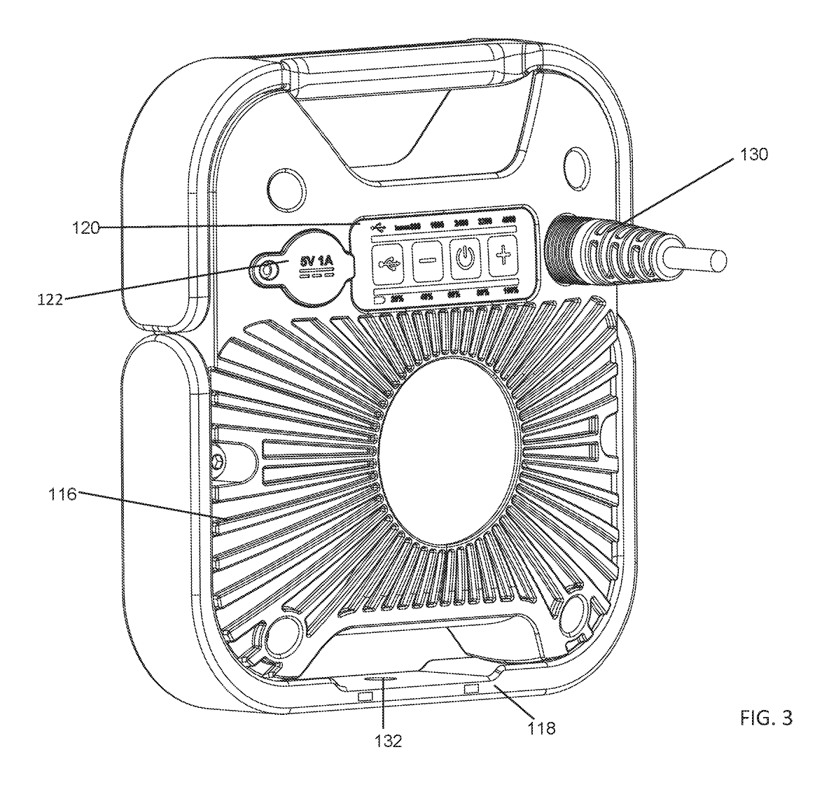

The housing 116 is an aluminum finned design extending across large portions of the front and back of the device as shown in FIGS. 2-3. The housing 116 is constructed of high quality aluminum, and the fins are designed for heat dissipation and impact resistance. The configuration is a strong construction design that allows product to drop safely from two meters.

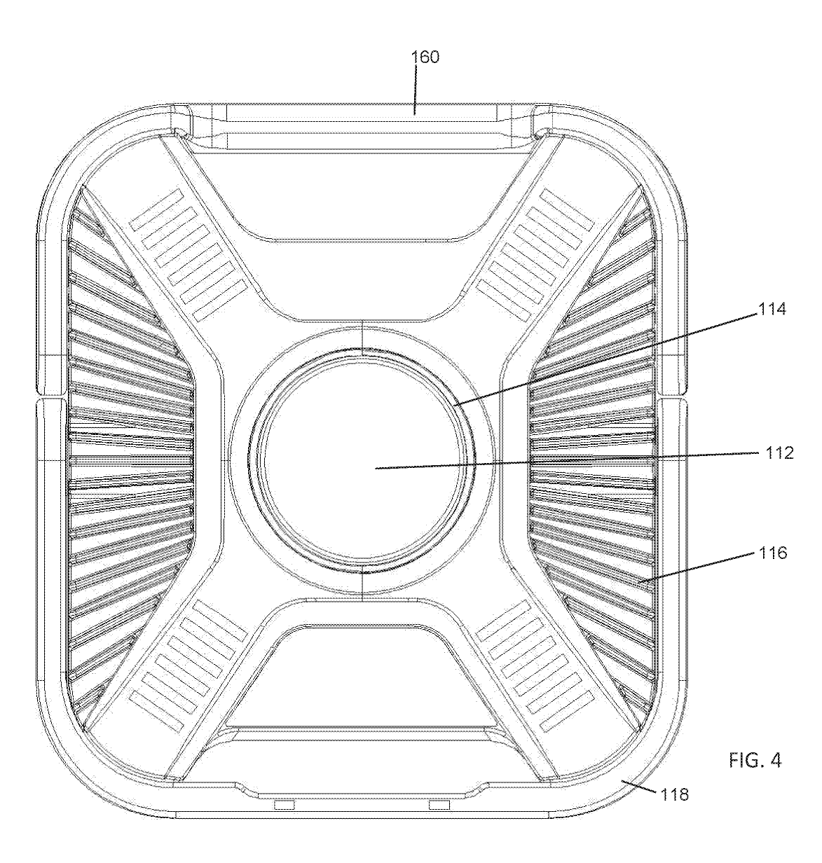

The front face of the portable lighting device 10 includes a high efficiency chip on board (“COB”) forward LED 112 used to illuminate, as shown in FIG. 4. A borosilicate glass lens protects the forward LED 112 in the example portable lighting device shown. The forward LED 112 is a high color rendition index chip on board LED. A reflector 114 is positioned around the LED 112 to better direct the light away from the device. It is contemplated that other light emitting technologies can be used in place of LED 112 including techniques such as arc, incandescent, and florescent bulbs. The reflector 114 is also a phosphorescent material which can make it easier to find the portable lighting device 110 in the dark, especially if the device is accidentally turned off.

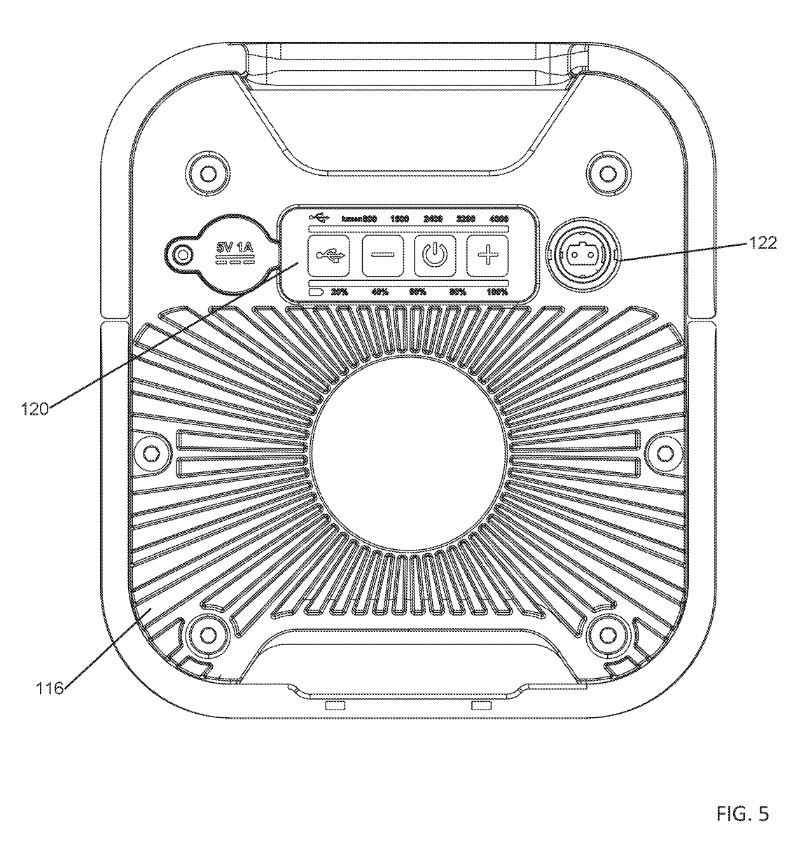

In the rear view shown in FIG. 5, a sensor panel 120 is shown. This sensor panel shows a variety of controls and displays. In the example shown in FIG. 5, there is a switch for activating the device and dimmer controls for adjusting the brightness of the forward LED 112. In addition to brightness control, the system can adjust the color temperature of the forward LED 112. This luminous flux adjustment by dimmer controls can be accomplished manually or by Bluetooth control by a user device, such as a cell phone or tablet for use of the dimmer function. In this example, the portable lighting device 110 will contain a wireless transceiver for Bluetooth communication with a user device. One of ordinary skill in the art will understand that the transceiver can be used or adapted for a wide range of wireless technologies such as WiFi, WiLAN, or any other suitable means of communication.

The portable lighting device 110 contains a lithium-ion rechargeable battery to provide power to the rest of the device. A charging port 122 is shown on the back of lighting device 110. This enables an “R+C system,” where R is “rechargeable” and C is “cable”. The product can be charged as a DC type unit, using the lithium-ion battery, but it also can be used with the cable hooked into external power as a conventional AC type electrical device.

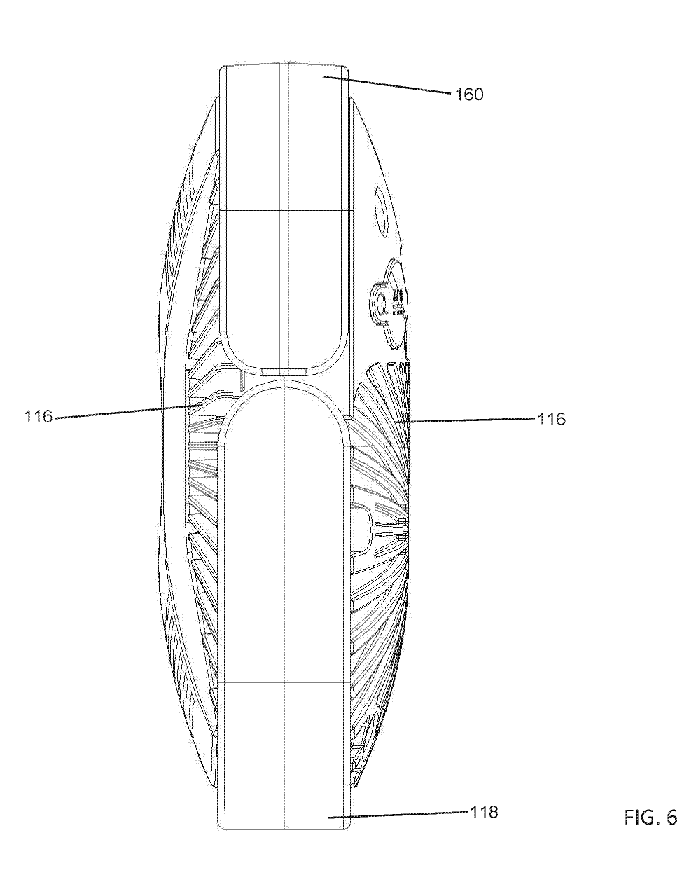

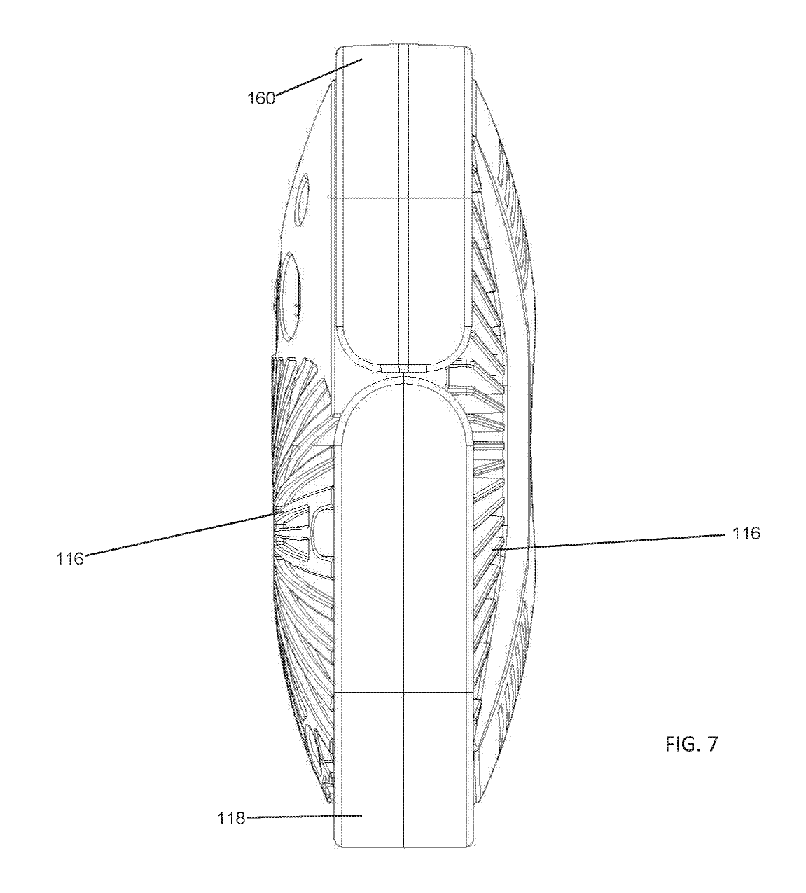

As shown in FIGS. 6-7, the example portable lighting device also includes a handle 160 and the rotating support bracket 118. The handle makes the portable lighting device 110 more easily carried. The rotating support bracket 118 has a mounting point 132 which allows the portable lighting device to be affixed to a tripod or other accessories. The rotating support bracket 118 can serve as a leg or stand alone, or as a pivot when the portable lighting device 110 is mounted.

The portable lighting device 110 is rated IP67 for water and dust resistance and can be used indoors and outdoors. The design of portable lighting device 110 prevents contact and the ingress of dust of more than a de minimis amount that provides no harm to the function of the device. It is also shielded from splashing water such that incidental contact with but not submersion in water.

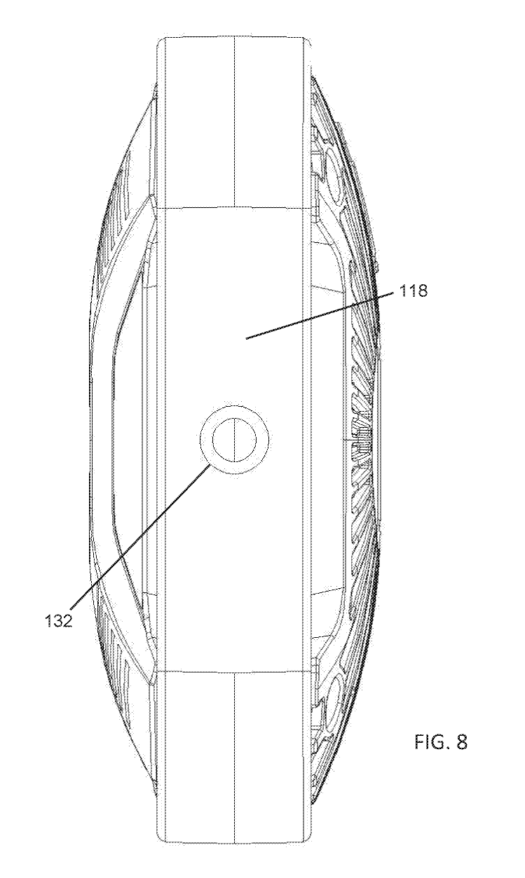

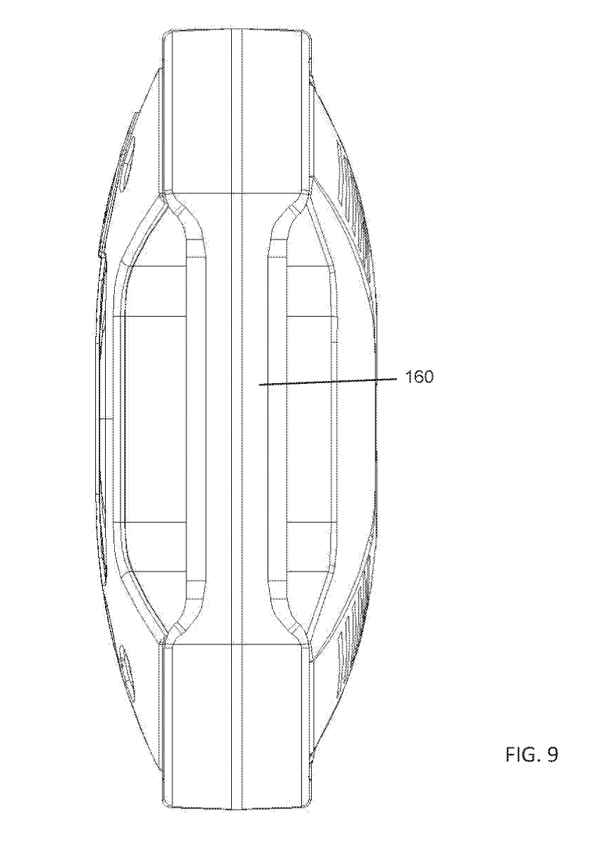

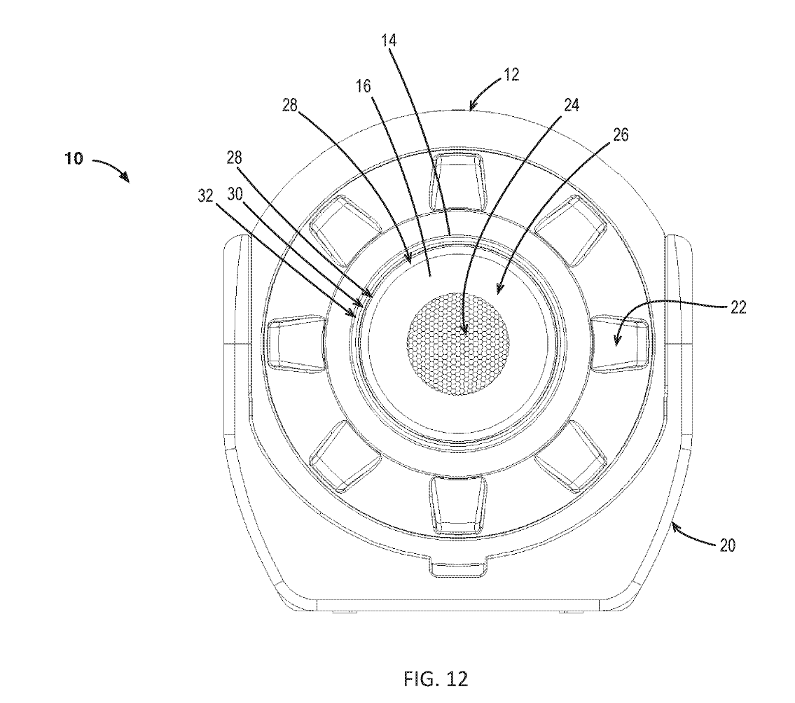

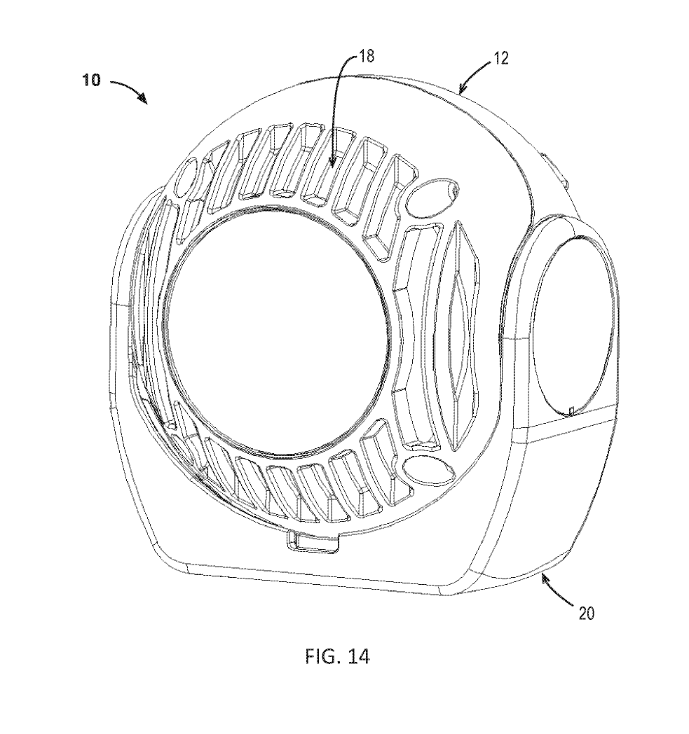

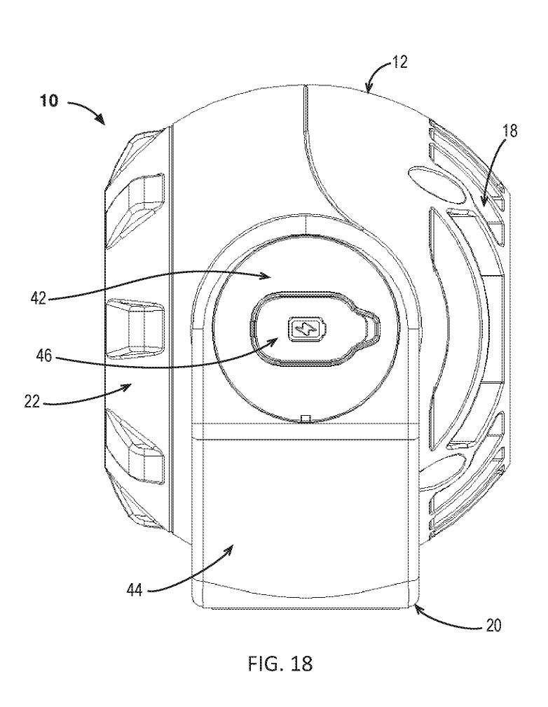

Turning to FIG. 8-18, there is illustrated a first example audio light 10 in accordance with the teachings of the present disclosure. The example audio light 10 comprises a housing 12, a lighting unit 16 received in an opening 14 of the housing 12, a speaker 18 disposed in the housing 12, and a bracket 20 connected to the housing 12.

The example audio light 10 may be configured for both indoor and outdoor uses. Thus, the housing 12 may be formed to provide the audio light 10 with impact resistance, water resistance, and/or dust resistance. In the example shown in FIGS. 8-18, the housing 12 is formed with high quality aluminum. However, as will be appreciated by one of ordinary skill in the art, the example housing 12 may be formed with any suitable material, such as for instance, plastic, carbon fiber, etc. The housing 12 may also be provided with a bumper 22 for increased impact resistance.

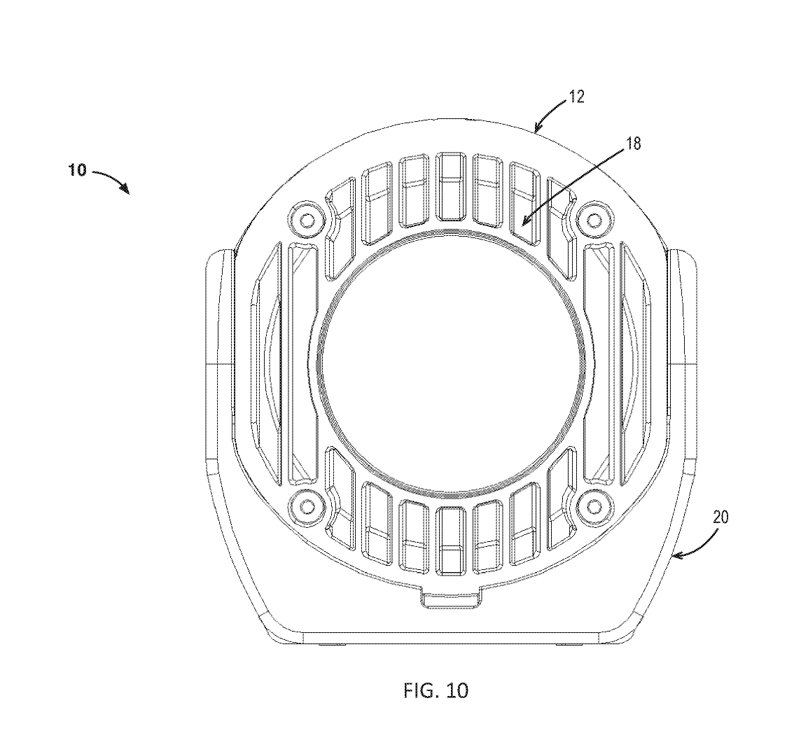

Referring to FIGS. 10-11 and 11-15, the lighting unit 16 includes a light source 24. The light source 24 may comprise one or more LEDs, incandescent bulbs, fluorescent bulbs, halogen bulbs, or the like. In the illustrated embodiment, the light source 24 comprises a high-efficiency, high color rendition index chip-on-board LED. The lighting unit 16 may also include a lens 26 positioned over the light source 24. The lighting unit 16 may further include a reflecting unit 28, so that the audio light 10 can be easily found in the dark. The reflecting unit 28 comprises a reflector 30 and a fluorescer 32. The lighting unit 16 may also include a dimmer (not shown) for adjusting the brightness of the light source 24.

The audio light 10 may additionally include a controller (not shown) disposed in the housing 12. The controller is operably connected to a transceiver (not shown). The controller is configured to receive control signals wirelessly at its transceiver from an external wireless device (not shown), such as a cellular phone, laptop computer, tablet computer, or the like, using radio frequency (RF) transmission. This can be a dedicated RF link, or it can be a wireless network conforming to the international standards such as the Wi-Fi, Bluetooth, or Ultra-Wide-Band (UWB) standards. Other wireless technologies not mentioned above, such as ultra-sound or optical, may also be applicable in this case. Control signals may include, for example, signals for turning on and off or dimming the light source 24, signals for controlling the volume of the speaker 18, signals for playing music through the speaker 18, and the like.

In one embodiment of the present disclosure, the controller is operably connected to the lighting unit 16 and the speaker 18, such that the controller can perform control of the lighting unit 16 and the speaker 18 in response to a control signal received from the external wireless device. For instance, if the controller receives a signal to dim the light source 24, the controller will cause the light source 24 to dim. In another embodiment of the present disclosure, the controller is operably connected to a light source driver (not shown) and a speaker driver (not shown). The light source driver and the speaker driver are configured to perform control of the light source 24 and the speaker 18, respectively. When the controller receives a control signal from the external wireless device, the controller forwards the control signal to the light source driver or the speaker driver. For instance, if the controller receives a signal to dim the light source 24, the controller will forward the signal to the light source driver, and the light source driver will cause the light source 24 to dim.

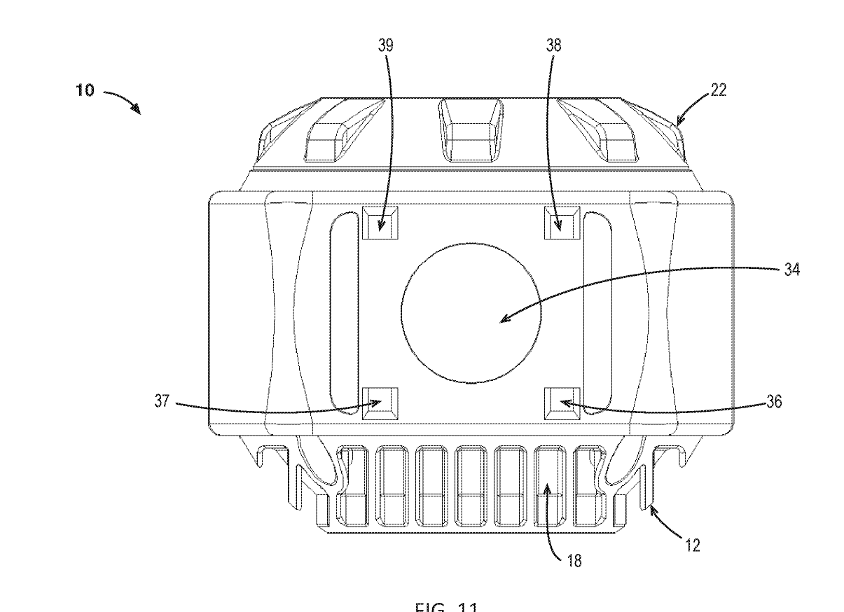

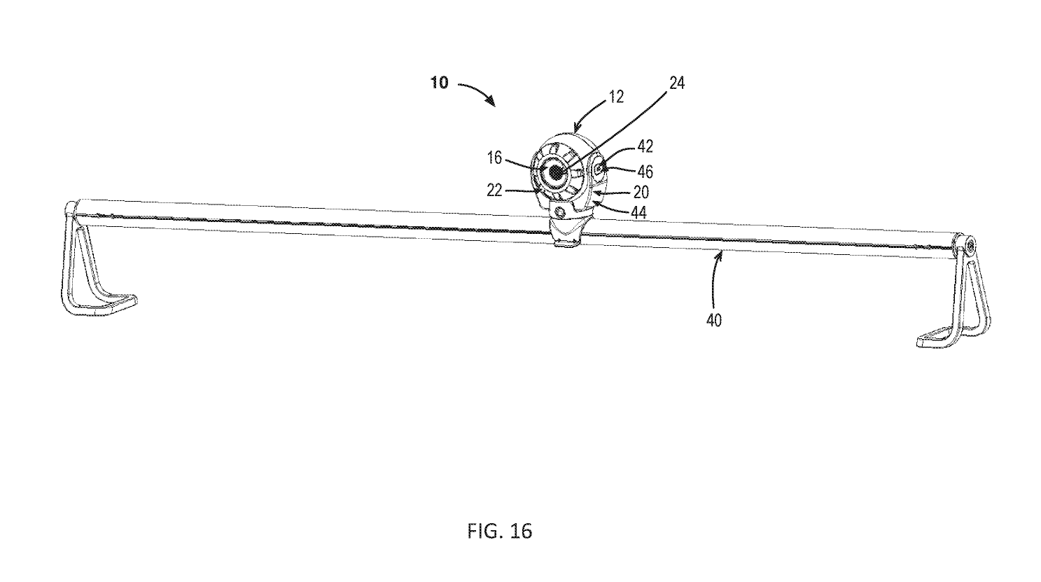

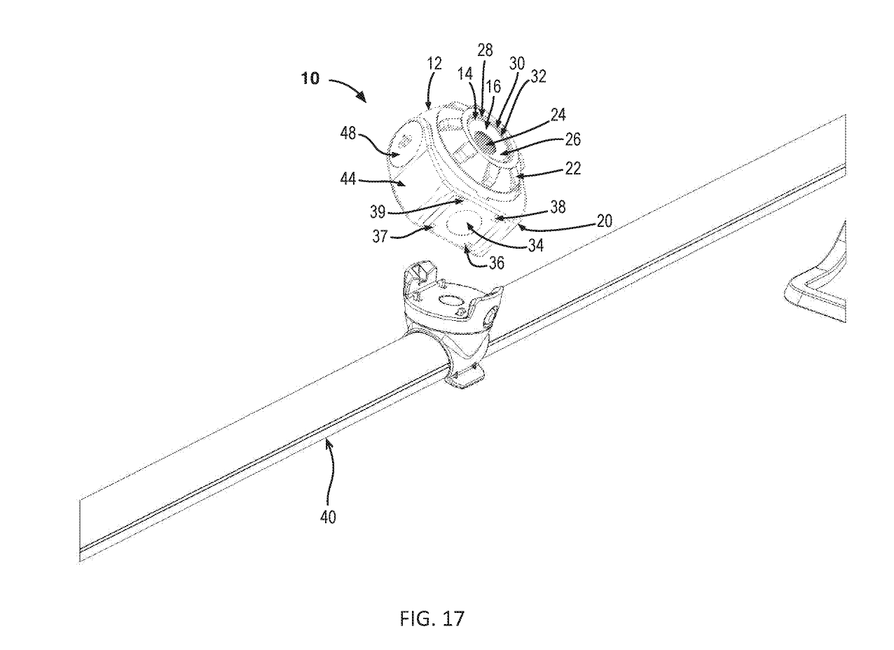

In this disclosure, the bracket 20 of the audio light 10 is pivotally connected to the housing 12 so that the housing 12 may rotate with respect to the bracket 20. It will be appreciated, however, that the bracket 20 need not be pivotally connected to the housing 12, but rather may be connected to the housing 12 in any suitable manner. As shown in FIGS. 11 and 17, the bracket 20 may include a magnet 34, so as to allow the bracket 20 to be magnetically coupled to a metal surface, such as the hood of a car. It will be understood that the size, number, and/or location of the magnet 34 may vary as necessary or desired. The bracket 20 may also include a plurality of holes 36, 37, 38, 39 for connecting the bracket 20 to a stand or support surface, such as a bar 40 as illustrated in FIGS. 16 and 17. It will be understood that the size, number, and/or location of the holes 36, 37, 38, 39 may vary as necessary or desired.

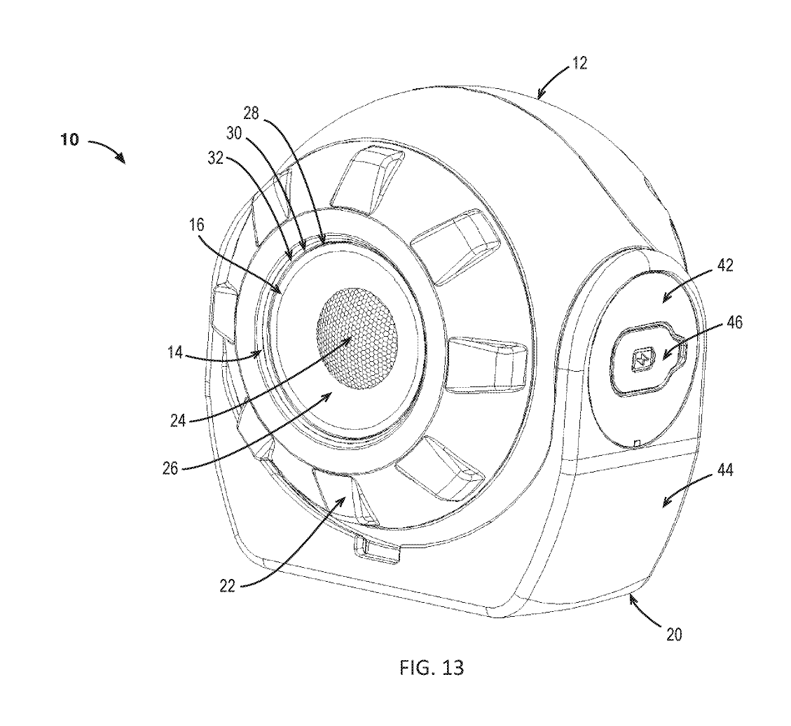

The audio light 10 may also include an internal power supply (not shown), such as a rechargeable lithium-ion battery, so that the audio light 10 may be operated even when disconnected from an external power source (not shown), such as a standard electrical outlet. As shown in FIGS. 13, 16, and 18, to facilitate charging of the internal power supply, an external charging socket 42 may be provided on an exterior surface 44 of the bracket 20. It will be understood that the location of the external charging socket 42 may vary as necessary or desired. The external charging socket 42 may include a protection cap 46 for protecting the external charging socket 42 from damage. The external charging socket 42 is configured to receive a first end of a cable (not shown). The cable may be any type of cable suitable for transferring an electrical signal, such as a Universal Serial Bus (USB) cable or the like. The cable may be selectively connected to the external power source at a second end of the cable.

In one mode of operation, when the first end of the cable is connected to the external charging socket 42, and the second end of the cable is connected to the external power source, the internal power supply is charged by the external power source. When the internal power supply is charged, the cable may be disconnected from the external charging socket 42, and the audio light 10 may be operated without being connected to the external power source by drawing power from the internal power supply. In an alternate mode of operation, when the first end of the cable is connected to the external charging socket 42 and the second end of the cable is connected to the external power source, the audio light 10 is powered directly by the external power source.

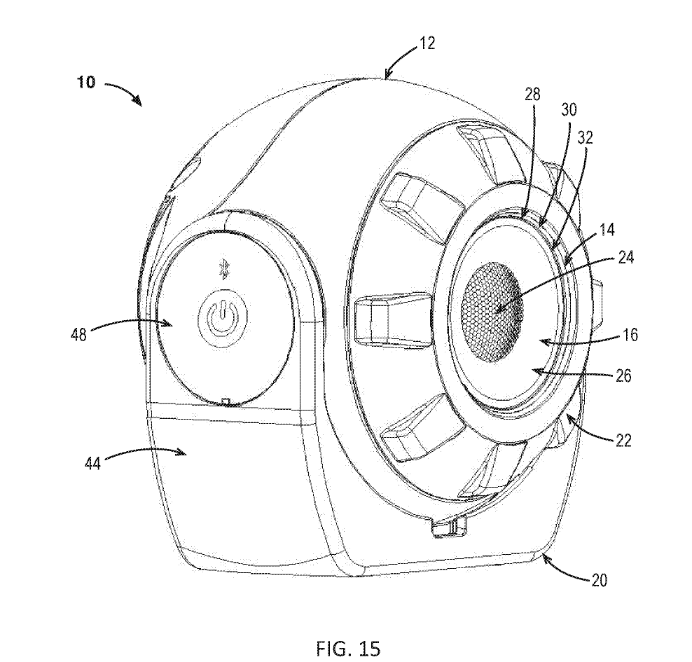

With reference to FIGS. 15, 17, and 19, the audio light 10 may additionally include a power button 48 positioned on the exterior surface 44 of the bracket 20 for turning on and turning off the audio light 10. It will be understood that the location of the power button 48 may vary as necessary or desired.

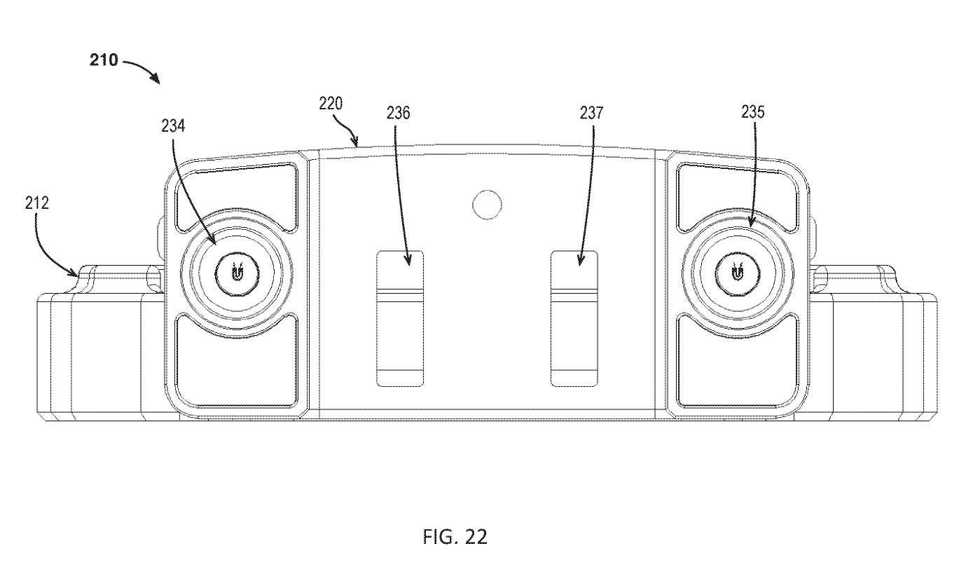

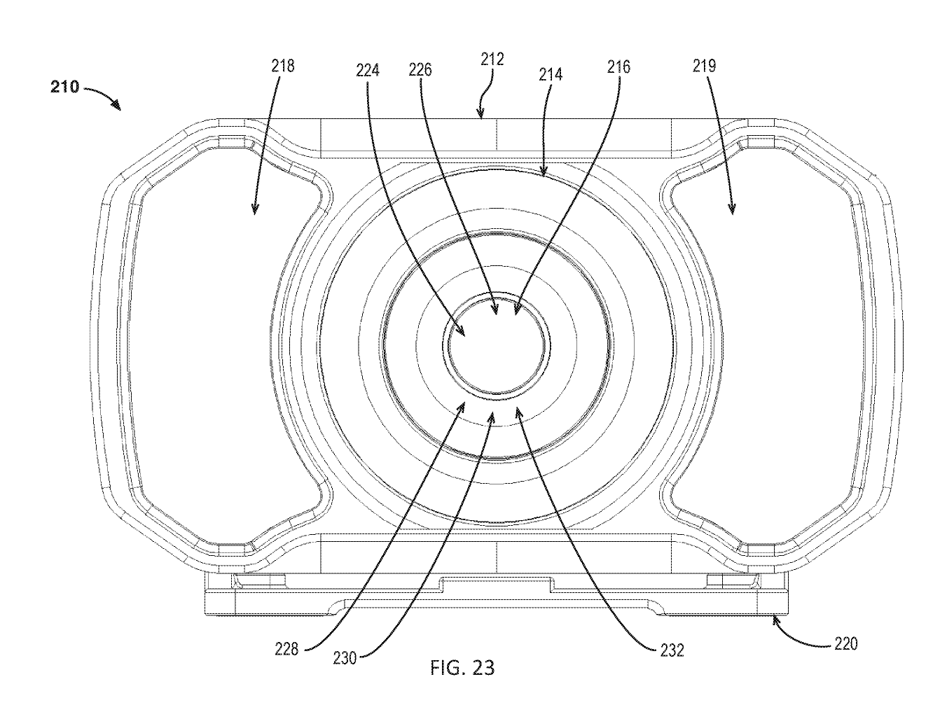

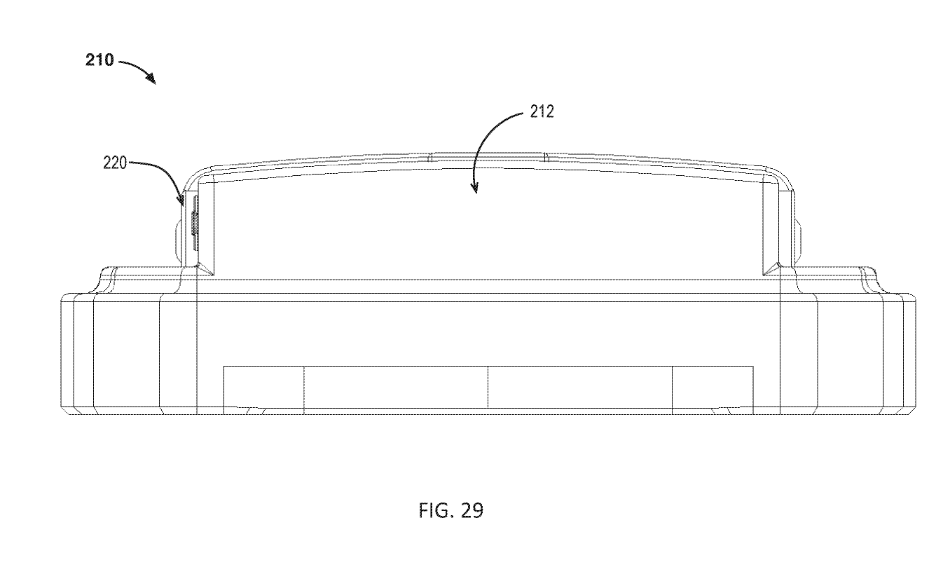

Referring now to FIGS. 22-29, there is illustrated a second example audio light 210 in accordance with the teachings of the present disclosure. The example audio light 210 comprises a housing 212, a lighting unit 216 received in an opening 214 of the housing 212, a pair of speakers 218, 219 disposed in the housing 212, and a bracket 220 connected to the housing 212.

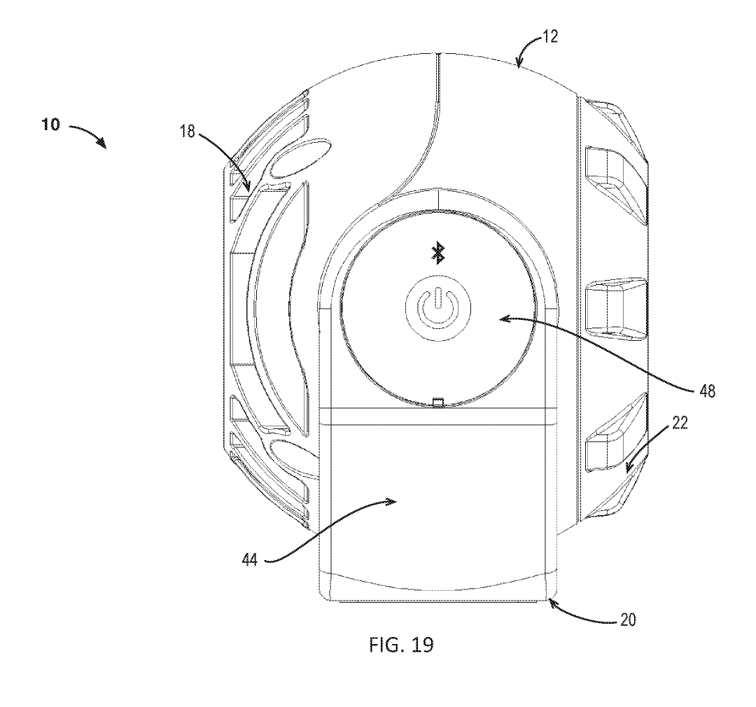

The example audio light 210 may be configured for both indoor and outdoor use. Thus, the housing 212 may be formed to provide the audio light 210 with impact resistance, water resistance, and/or dust resistance. In the example shown in FIGS. 19-27, the housing 212 is formed with high quality aluminum. However, as will be appreciated by one of ordinary skill in the art, the example housing 212 may be formed with any suitable material, such as for instance, plastic, carbon fiber, etc.

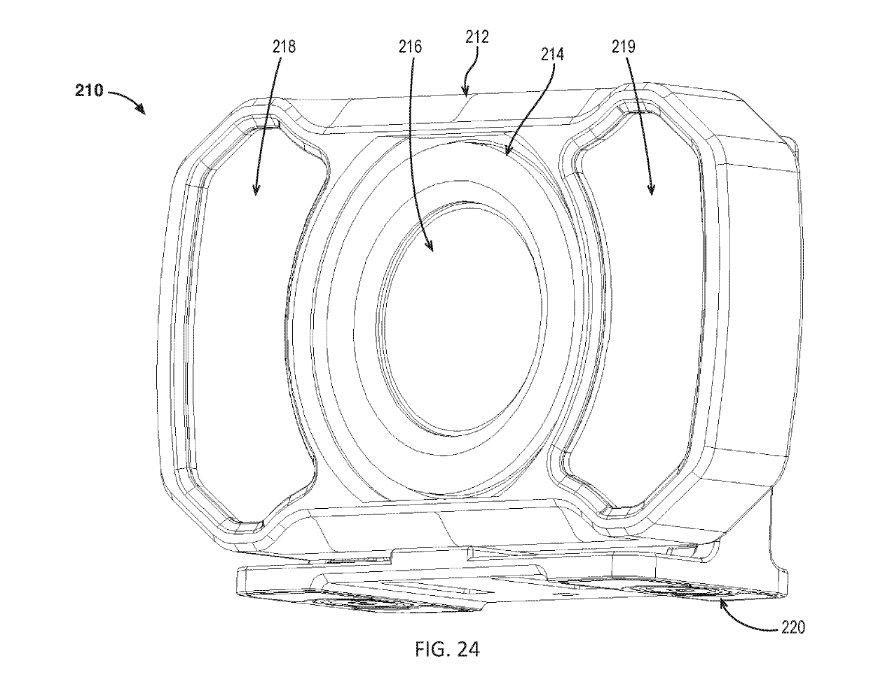

Referring now to FIGS. 24-26, the lighting unit 216 includes a light source 224. The light source 224 may comprise one or more LEDs, incandescent bulbs, fluorescent bulbs, halogen bulbs, or the like. In the illustrated embodiment, the light source 224 comprises a high-efficiency, high color rendition index chip-on-board LED. The lighting unit 216 may also include a lens 226 positioned over the light source 224. The lighting unit 216 may further include a reflecting unit 228, so that the audio light 210 can be easily found in the dark. The reflecting unit 228 comprises a reflector 230 and a fluorescer 232. The lighting unit 216 may also include a dimmer (not shown) for adjusting the brightness of the light source 224.

The audio light 210 may additionally include a controller (not shown) disposed in the housing 212. The controller is operably connected to a transceiver (not shown). The controller is configured to receive control signals wirelessly at its transceiver from an external wireless device (not shown), such as a cellular phone, laptop computer, tablet computer, or the like, using radio frequency (RF) transmission. This can be a dedicated RF link, or it can be a wireless network conforming to the international standards such as the Wi-Fi, Bluetooth, or Ultra-Wide-Band (UWB) standards. Other wireless technologies not mentioned above, such as ultra-sound or optical, may also be applicable in this case. Control signals may include, for example, signals for turning on and off or dimming the light source 224, signals for controlling the volume of the pair of speakers 218, 219, signals for playing music through the pair of speakers 218, 219, and the like.

In one embodiment of the present disclosure, the controller is operably connected to the lighting unit 216 and the pair of speakers 218, 219, such that the controller can perform control of the lighting unit 216 and the pair of speakers 218, 219 in response to a control signal received from the external wireless device. For instance, if the controller receives a signal to dim the light source 224, the controller will cause the light source 224 to dim. In another embodiment of the present disclosure, the controller is operably connected to a light source driver (not shown) and a speaker driver (not shown). The light source driver and the speaker driver are configured to perform control of the light source 224 and the pair of speakers 218, 219, respectively. When the controller receives a control signal from the external wireless device, the controller forwards the control signal to the light source driver or the speaker driver. For instance, if the controller receives a signal to dim the light source 224, the controller will forward the signal to the light source driver, and the light source driver will cause the light source 224 to dim.

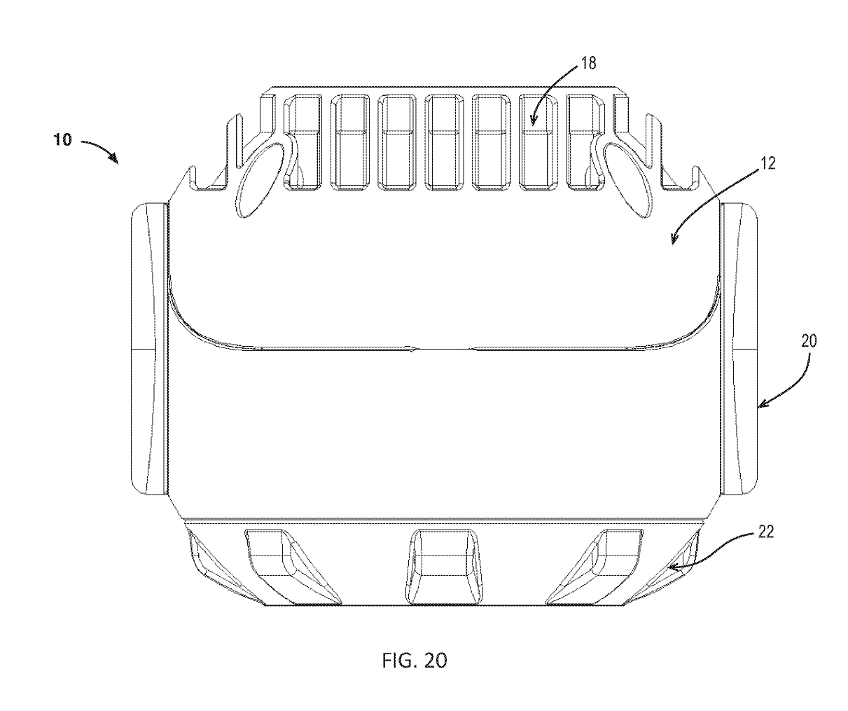

In this disclosure, the bracket 220 of the audio light 210 is pivotally connected to the housing 212 so that the housing 212 may rotate with respect to the bracket 220. It will be appreciated, however, that the bracket 220 need not be pivotally connected to the housing 212, but rather may be connected to the housing 212 in any suitable manner. As shown in FIG. 20, the bracket 220 may include a pair of magnets 234, 235, so as to allow the bracket 220 to be magnetically coupled to a metal surface, such as the hood of a car. It will be understood that the size, number, and/or location of the pair of magnets 234, 235 may vary as necessary or desired. The bracket 220 may also include a plurality of holes 236, 237 for connecting the bracket 220 to a stand or support surface (not shown). It will be understood that the size, number, and/or location of the holes 236, 237 may vary as necessary or desired.

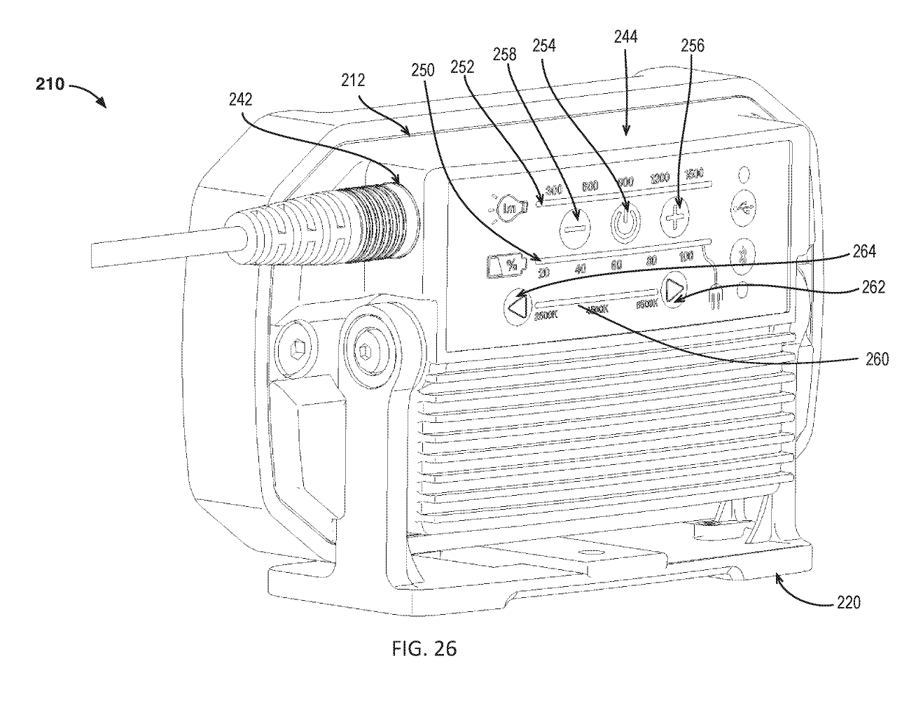

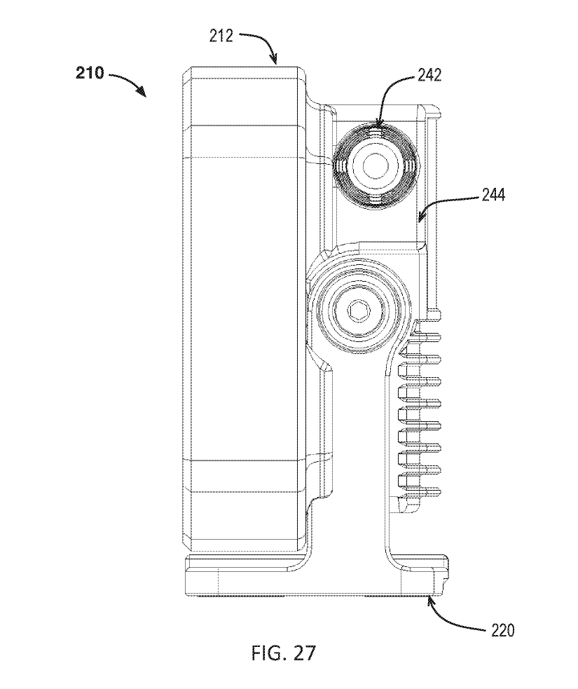

The audio light 210 may also include an internal power supply (not shown), such as a rechargeable lithium-ion battery, so that the audio light 210 may be operated even when disconnected from an external power source (not shown), such as a standard electrical outlet. As shown in FIGS. 26 and 27, to facilitate charging of the internal power supply, an external charging socket 242 may be provided on an exterior surface 244 of the housing 212. It will be understood that the location of the external charging socket 242 may vary as necessary or desired. The external charging socket 242 is configured to receive a first end of a first cable (not shown). The first cable may be any type of cable suitable for transferring an electrical signal, such as a Universal Serial Bus (USB) cable or the like. The first cable may be selectively connected to the external power source at a second end of the first cable.

In one mode of operation, when the first end of the first cable is connected to the external charging socket 242, and the second end of the first cable is connected to the external power source, the internal power supply is charged by the external power source. When the internal power supply is charged, the first cable may be disconnected from the external charging socket 242, and the audio light 210 may be operated without being connected to the external power source by drawing power from the internal power supply. In an alternate mode of operation, when the first end of the first cable is connected to the external charging socket 242 and the second end of the first cable is connected to the external power source, the audio light 210 is powered directly by the external power source.

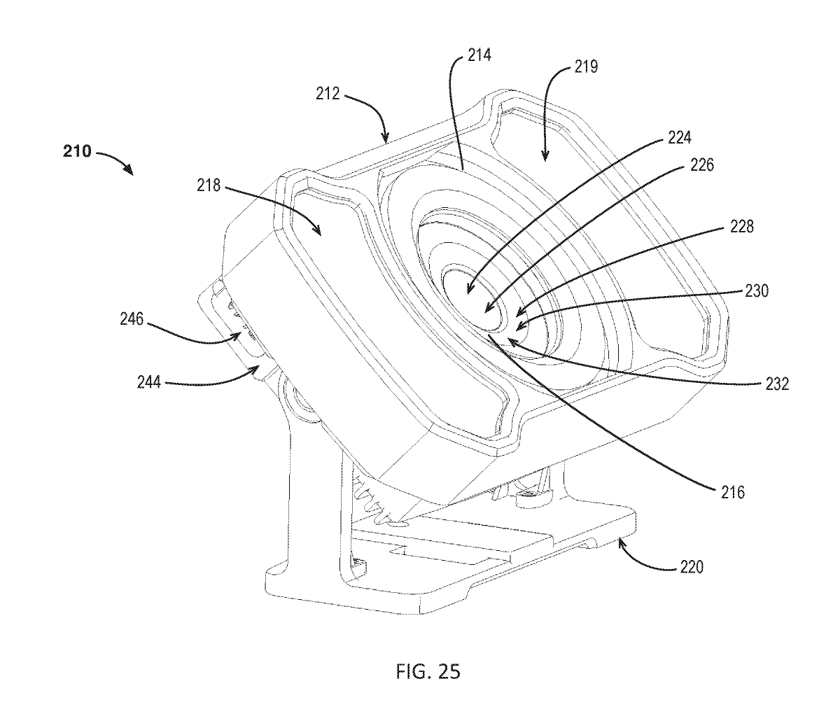

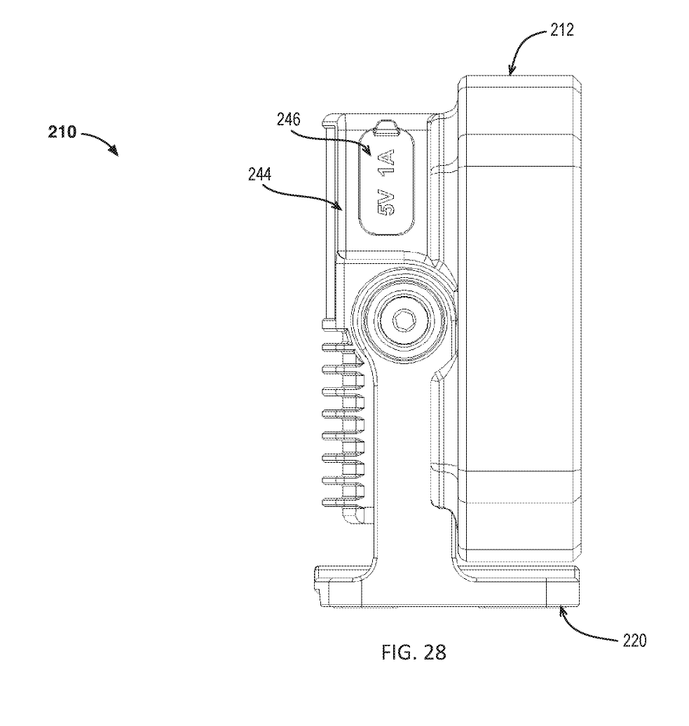

As shown in FIGS. 25 and 28, the audio light 210 may also include a power bank 246 provided on the exterior surface 244 of the housing 212. It will be understood that the location of the power bank 246 may vary as necessary or desired. The power bank 246 is configured to receive a first end of a second cable (not shown). The second cable may be any type of cable suitable for transferring an electrical signal, such as a Universal Serial Bus (USB) cable or the like. The second cable may be connected to an external device (not shown) at a second end of the second cable, such that when the first end of the second cable is connected to the power bank 246 and the second end of the second cable is connected to the external device, an electrical signal may travel from the audio light 210 to the external device. For instance, the electrical signal may be used to charge a cell phone.

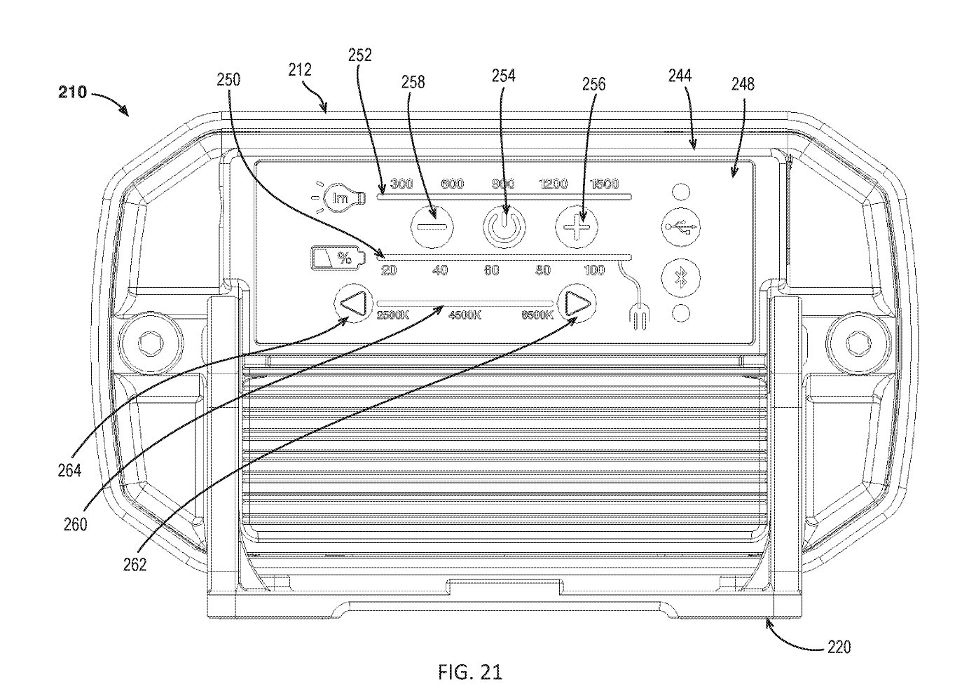

As shown in FIGS. 21 and 27, the audio light 210 may additionally include an interactive display 248 positioned on the exterior surface 244 of the housing 212. It will be understood that the location of the interactive display 248 may vary as necessary or desired. The interactive display 248 may include, for example, a battery capacity indicator 250 for indicating the charge left in the internal power supply, a luminous flux dimmer 252 for indicating the brightness of the light source 224, and a power button 254 for turning on and turning off the audio light 210. The interactive display 248 may also include a plus button 256 for increasing the brightness of the light source 224 and/or increasing the volume of the pair of speakers 218, 219. The interactive display 248 may further include a minus button 258 for decreasing the brightness of the light source 224 and/or decreasing the volume of the pair of speakers 218, 219. The interactive display 248 may additionally include a color temperature indicator 260 for indicating the color temperature of the light source 224, as well as a pair of buttons 262, 264 for increasing and decreasing the color temperature of the light source 224, respectively. It will be understood that the components, features, and layout of the interactive display 248 are not limited to that shown in the illustrated example, but rather may vary as necessary or desired.

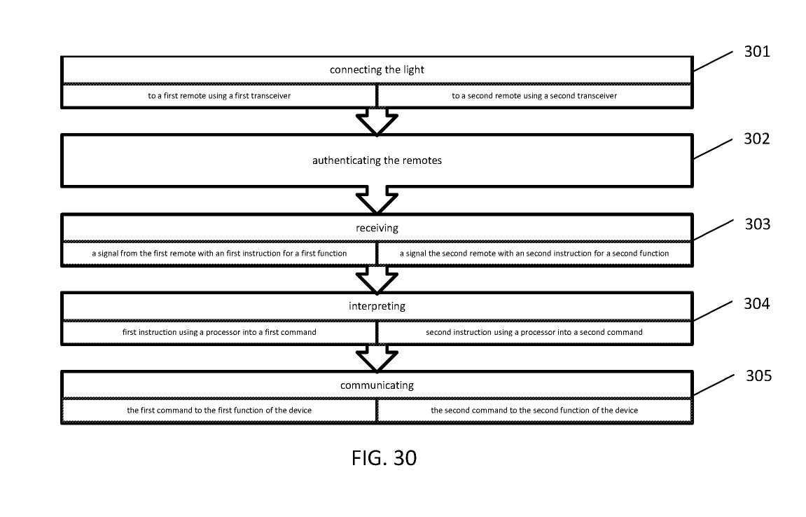

Referring now to FIG. 30, which shows a flowchart showing a method of using a multi-functional flashlight according to the teachings of this disclosure. At block 301, the user connects the light to a first remote using a first transceiver, such as a Bluetooth transceiver, and then repeats the process with a second remote. The second remote is connected in this example using a second transceiver. At block 302, the multi-functional flashlight validates and authenticates each of the remotes. At block 303, the flashlight receives a signal from each of the remotes with instructions. The instructions are differentiated for different functions of the device. The first remote sends a first instruction for a first function. The second remote sends a second instruction for a second function. At block 304, the light interprets the instructions into a first and second instruction for the appropriate function it is meant for. At block 305, the command is communicated to that function, namely the first command from the first remote to the first function and second command from the second remote to the second function.

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents.

What is claimed is:

1. A method of using a multi-functional lighting device with at least two functions, comprising
connecting the multi-functional lighting device to a first remote using a first transceiver and a second remote using a second transceiver;
authenticating the first and second remotes;
receiving a signal from the first remote with an first instruction for a first function or the second remote with an second instruction for a second function;
interpreting the first instruction or second instruction using a processor into a first or second command, respectively; and
communicating the first and second command to the first or second function of the device, respectively.

2. The method of using a multi-functional lighting device of claim 1, wherein the first function of the device is a lighting element.

3. The method of using a multi-functional lighting device of claim 1, wherein the second function is an audio speaker.

4. The method of using a multi-functional lighting device of claim 1, wherein the second function is a charging port.

5. The method of using a multi-functional lighting device of claim 5, wherein the charging port can be used to provide power to an external device.

6. The method of using a multi-functional lighting device of claim 1, wherein the transceiver uses BLUETOOTH.

7. The method of using a multi-functional lighting device of claim 1, wherein the remote is a cellular phone.

8. The method of using a multi-functional lighting device of claim 1, further comprising confirming the command was executed.

9. The method of using a multi-functional lighting device of claim 8, further comprising a communicating a status update back to the remote.

10. A method of controlling a multi-functional lighting device with a first remote comprising
connecting the multi-functional lighting device to the first remote in addition to connecting at least a second remote;
providing a user identification to the multi-functional lighting device from the first remote;
sending a signal from the remote with an instruction relating to one of at least two functions of the multi-functional lighting device; and
receiving a status update relating to the function from the multi-functional lighting device.

11. The method of using a multi-functional lighting device of claim 10, wherein the first function of the device is a lighting element.

12. The method of using a multi-functional lighting device of claim 10, wherein the second function is a speaker.

13. The method of using a multi-functional lighting device of claim 10, wherein the connection uses BLUETOOTH.

14. The method of using a multi-functional lighting device of claim 10, wherein the second function is a charging port.

15. The method of using a multi-functional lighting device of claim 14, wherein the charging port can be used to provide power to an external device.

16. The method of using a multi-functional lighting device of claim 10, wherein the remote is a cellular phone.

17. The method of using a multi-functional lighting device of claim 10, further comprising confirming the command was executed.

18. The method of using a multi-functional lighting device of claim 17, further comprising a communicating a status update back to the remote.

19. A remote controlled multi-functional lighting device with a first function and a second function, comprising:
a lighting element positioned in a housing;
a battery system coupled to an inside of the housing and operably connected to and enabling the lighting element to emit light;
a first receiver and a second transceiver configured to connect the multi-functional lighting device to a first remote and a second remote respectively and receive a signal from the first remote with an first instruction for the first function or the second remote with an second instruction for the second function;
a controller configured to authenticate the first and second remotes and interpret the first instruction or second instruction using a processor into a first or second command, respectively; and
wherein upon receiving first or second command, the controller executes the first and second command to the first or second function of the device, respectively.

20. The remote controlled multi-functional lighting device of claim 19 wherein at least one of the first function or second function of the device is selected from the group comprising: a lighting element, an audio speaker, or a charging port.
